(19) United States
(12) Patent Application Publication
(10) Pub. No.: US 2007/0214316 A1
(43) Pub. Date: Sep. 13, 2007

(54) RAID system and method in mobile terminal

(75) Inventor: Hyung-Hoon Kim, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/714,685

(22) Filed: Mar. 6, 2007

(30) Foreign Application Priority Data
Mar. 7, 2006 (KR) 21515/2006

(51) Int. Cl. G06F 12/16; G06F 12/14

(52) U.S. Cl. 711/114; 711/163

(57) ABSTRACT

Disclosed is a Redundant Arrays of Independent Drives (RAID) system and a RAID method in a mobile terminal. The system includes a plurality of flash memories for storing data for operation performance of the mobile terminal and a RAID system for controlling the flash memories to be recognized as one of more areas, thereby providing a large amount of storage space, securing the reliability of stored data, and improving an access rate to the stored data. Additionally, a plurality of flash memories having stored important data for the performance of the mobile terminal are set as a write-protect area, thereby preventing data in the flash memories from being unintentionally modified.

### PRIORITY

This application claims the benefit under 35 U.S.C. §119(a) of an application entitled “RAID System And Method In Mobile Terminal” filed in the Korean Industrial Property Office on Mar. 7, 2006 and assigned Serial No. 2006-21515, the contents of which are hereby incorporated by reference.

### BACKGROUND OF THE INVENTION

1. Field of the Invention

The present invention relates generally to a Redundant Arrays of Independent Drives (RAID) system and method in a mobile terminal, and more particularly to a RAID system for controlling a plurality of flash memories, which store data for executing operations in a mobile terminal, to be recognized as one or more areas, and a method for preventing flash memory data from being unintentionally modified.

2. Description of the Related Art

In general, flash memories of a mobile terminal are classified into a plurality of areas for a basic operation code, an operation program, and service and user data, and includes memory maps for storing a corresponding code, program or data in each corresponding area.

The basic operation code is for initial setting the mobile terminal. Upon performing initial setting of the mobile terminal, a controller of the mobile terminal accesses the basic operation code by copying it from the flash memory to a primary static memory, and performs the initial setting of the mobile terminal according to a procedure coded in the basic operation code.

The operation program is for driving the mobile terminal so that it can carry out basic functions after performing the initial setting. The operation program includes a static application and an embedded application, for example. The static application is made by a mobile terminal manufacturer in order to execute the basic functions of the mobile terminal, and the embedded application is made by a mobile communication network operator in order to enable the mobile terminal to provide basic communication services such as audio and data communication by using a mobile communication network.

When a plurality of flash memories are installed in a mobile terminal so as to execute an application, the controller directly brings the application from the flash memory to a secondary static flash memory which is randomly accessible and performs the application because the flash memory is accessed block by block instead of byte by byte. When the mobile terminal is powered on, the controller of the mobile terminal copies the basic operation code from the primary to the secondary flash memory and initializes the mobile terminal through random access to the basic operation code of the secondary flash memory. After the initial setting of the mobile terminal has been completed, the controller drives the mobile terminal by copying the operation program from the secondary flash memory to one binary and performing random access to the operation program.

The operation program, which has been copied from the primary flash memory to the secondary flash memory upon driving the mobile terminal, as described above, continuously occupies an area of the secondary flash memory during the powering on of the mobile terminal. As a result, when another application is executed after the mobile terminal is driven, the memory storage space occupied by the operation program cannot be utilized, so that the secondary flash memory is inefficiently used.

Therefore, the storage space of the secondary flash memory must be proportionally larger as the size of the operation program stored in the primary flash memory increases. In addition, the size of an operation program is generally determined based on the size of the embedded applications, so that the storage area of the secondary flash memory is generally dependent on the size of the embedded application.

Therefore, there is a problem in that the storage space of a flash memory must be larger so as to meet requirements of the user as mobile communication subscribers require higher-quality mobile communication service.

### SUMMARY OF THE INVENTION

Accordingly, the present invention has been made to solve the above-mentioned problems occurring in the prior art, and the present invention provides a RAID system and a RAID method, which control a plurality of flash memories connected to the RAID system of a mobile terminal to be recognized as one or more areas, thereby providing a large amount of storage space, securing the reliability of stored data and improving an access rate to the stored data.

Also, the present invention provides a RAID system and a RAID method which set up an area of a flash memory, having stored important data to be executed in a mobile terminal, as a write-protect state, thereby preventing unintentional modification of flash memory data.

In accordance with the present invention, there is provided a RAID system which includes a plurality of flash memories for storing data used to perform an operation in the mobile terminal, and a RAID controller for controlling the plurality of flash memories to be recognized as at least one area.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates the configuration of a RAID system in a mobile terminal according to the present invention;

FIG. 2 illustrates the configuration of flash memories in the RAID system according to the present invention; and

FIG. 3 illustrates the operation of the RAID system in a mobile terminal according to the present invention.

### DETAILED DESCRIPTION OF THE PREFERRED EMBODIMENTS

Hereinafter, preferred embodiments of the present invention will be described with reference to the accompanying drawings. In the following description, the same elements will be designated by the same reference numerals although they are shown in different drawings. Further, various specific definitions found in the following description, such as specific values of packet identifications and contents of displayed information, are provided only to assist in a general understanding of the present invention, and it will be apparent to those skilled in the art that the present invention can be implemented without such definitions. Further, in the following description of the present invention, a detailed description of known functions and configurations incorporated herein will be omitted for the sake of clarity and conciseness.

Generally, a RAID system is for handling a plurality of disk drives as one device in which the RAID system independently operates each of the disk drives. The RAID system has advantages in that it can replace one large expensive drive with small and inexpensive disk drives connected to each other, and preserve data when a failure occurs. RAID systems are classified into various levels according to the configurations thereof. The fundamental concept of the RAID technology is disclosed in a publication entitled “A case for Redundant Arrays of Inexpensive disks” written in 1987 by David A. Patterson, et al. in the University of California located in Berkeley.

According to the publication by Patterson et al., RAID systems are classified into five types, i.e., to RAID levels 1 to 5.

First, according to RAID level 1, N pieces of disk data are stored in N disks, and are simultaneously copied and stored in different mirror disks. When data is written, the data must be stored in two disks at all times, and when data is read, it is possible to select a first disk to which an access rate is higher than that to a second disk of the two and to read the data from the first disk. Although one disk fails, service can be continuously provided through the other disk storing duplicate data.

RAID level 2 is a scheme for protecting data using a hamming code. RAID level 2 requires a lower cost than RAID level 1 of the mirror scheme.

RAID level 3 is constructed in such a manner that one parity disk is added to the data disk group including N data disks. When data is written, the data is distributed bit by bit or byte by byte and stored in the disks, a parity obtained through an exclusive OR of data stored in each data disk is stored in the parity disk. When data is read, it is necessary to simultaneously access the N disks, and it is possible to recover data by using parity data stored in the parity disk when one disk fails.

RAID level 4 is constructed by N+1 disks, in which data is stored in the N disks and a parity is stored in a remaining disk, similar to RAID level 3. A point of difference between RAID level 4 and RAID level 3 is that distribution and storage of data in RAID level 4 is performed block by block. Therefore, when data is written, it is necessary to access one data disk and parity disk, and when data is read, it is necessary to access only one disk. When one disk fails, it is possible to recover data by using the parity stored in the parity disk.

RAID level 5 is constructed to store data block by block, similar to RAID level 4. However, according to RAID level 5, a parity is distributed and stored in each disk together with data, instead of being fixedly stored in one disk. Data reading, data writing and data recovering upon a failure of one disk in RAID 5 are performed in the same manner as those in RAID 4. In addition, there are RAID level 0 for distributing and storing only data without using an auxiliary data, and RAID level 6 employing a P+Q error recovering method by using Reed-Solomon code.

Since RAID level 6 can recover information even when two disks fail at the same time, RAID level 6 has higher system availability than any other RAID level using a parity. Currently, most RAID systems support RAID level 0, 1, 3 and 5 and RAID level 0/1 which is a combination of RAID levels 0 and 1, and a RAID level suitable for the application environment of a user is selected and used.

Meanwhile, with the development of industrial technology, various efforts are being made to use the RAID system for storing data in a flash memory instead of a hard disk.

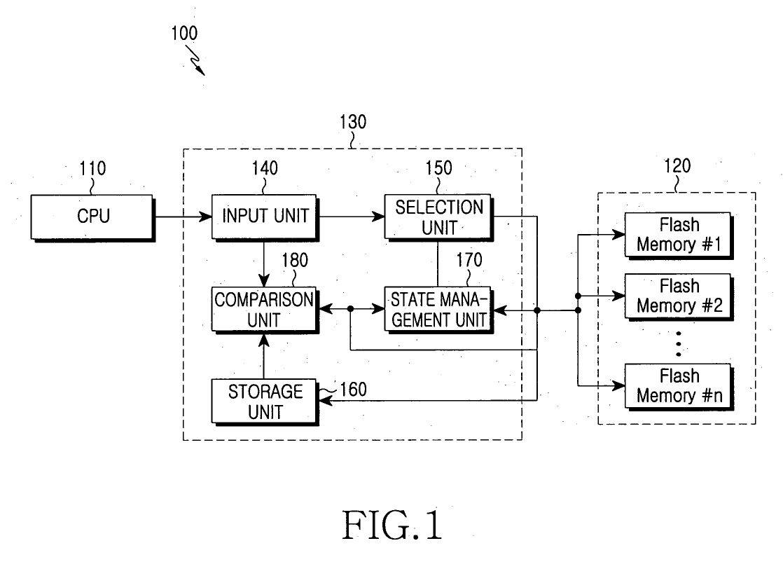

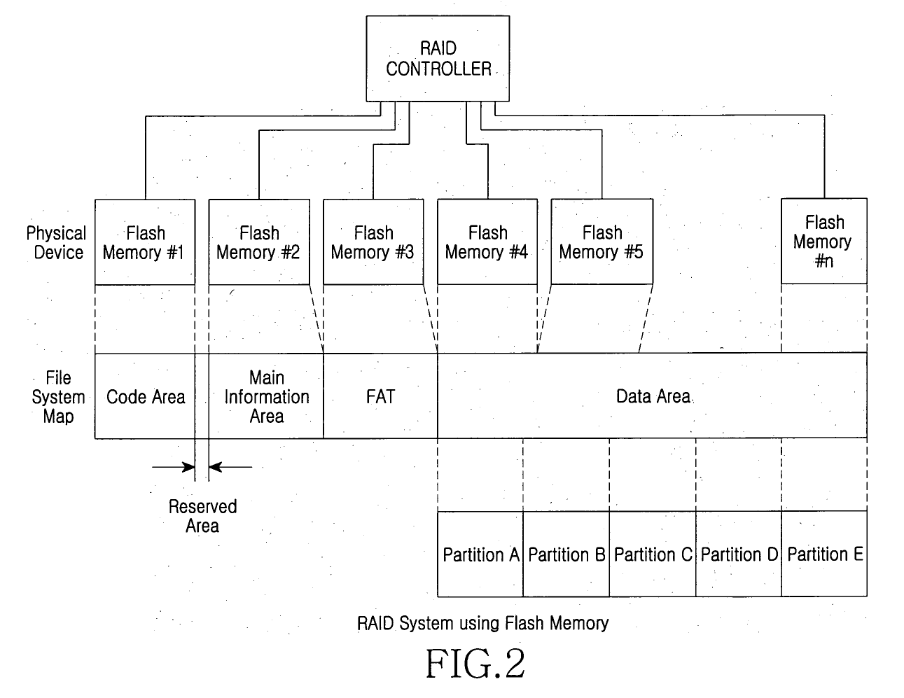

FIG. 1 illustrates the configuration of a RAID system in a mobile terminal according to the present invention, and FIG. 2 illustrates flash memories of the RAID system according to the present invention.

As illustrated in FIG. 1, the RAID system 100 in a mobile terminal includes a Central Processing Unit (CPU) 110, N flash memories 120 and a RAID controller 130.

The CPU 110 executes programs for configuration, management and operation in the RAID system 100. Also, the CPU 110 appropriately processes reading and writing requests by interpreting the requests for data input/output to/from the flash memories 120.

As illustrated in FIG. 2, the N flash memories 120 provide a code area for storing programs executed according to control commands of the RAID controller 130 and storing code data for the operation of a mobile terminal, a main data area such as a master boot record area, a File Allocation Table (FAT) area for a file system, and a data area for storing information in a random unit area.

The RAID controller 130 functions to enable the N flash memories 120 to be recognized as one or more areas. The RAID controller 130 includes an input unit 140 connected to the central processing unit 110, a selection unit 150, a storage unit 160, a state management unit 170 and a comparison unit 180.

The input unit 140 is connected to the central processing unit 110 so as to receive a control command.

The selection unit 150 receives the control command, which has been transmitted from the CPU 110, through the input unit 140, and selects which flash memory 120 will operate from among N flash memories 120.

The storage unit 160 stores data regarding the initial state of the flash memories 120.

The state management unit 170 perceives the states of the N flash memories 120 to identify the connection states thereof, checks whether data of a data area, which is preserved in a unit area so as to be recognized by the CPU 110, is writable data or data of a read-only area such as a master boot record area, and sets the area of each corresponding flash memory 120 as a write-protect area or a writable area according to a result of the checking.

The comparison unit 180 compares data about an initial state of the flash memory 120, which has been stored in the storage unit 160 according to a control command of the central processing unit 110, with data currently stored in the area of the flash memory 120 searched by the state management unit 170 so as to determine whether the two pieces of data corresponding with each other. Then, according to a result of the comparison, the state management unit 170 transits the area of the flash memory 120 into a writable or write-protect state.

When the RAID controller 130, which waits for transmission of a command from the CPU 110, receives a command related to data processing of the flash memory 120 from the CPU 110, the RAID system 100 identifies the type of the received command. Then, when the command corresponds to a read command, the RAID system 100 searches flash memory 120 for data requested by the CPU 110, and transmits the data to the CPU 110 when the data has been stored in the flash memory 120.

When the command received by the RAID controller 130 from the CPU 110 corresponds to a write command, the RAID system 100 checks whether location information in which the data transmitted from the CPU 110 is to be recorded, is stored in the flash memory 120. When the corresponding location information is stored in the flash memory 120, the RAID system 100 records the data transmitted from the CPU 110 on the data area of the flash memory 120 including the location information, on the area of the corresponding flash memory 120, and then transits the area of the corresponding flash memory 120 into a changed state.

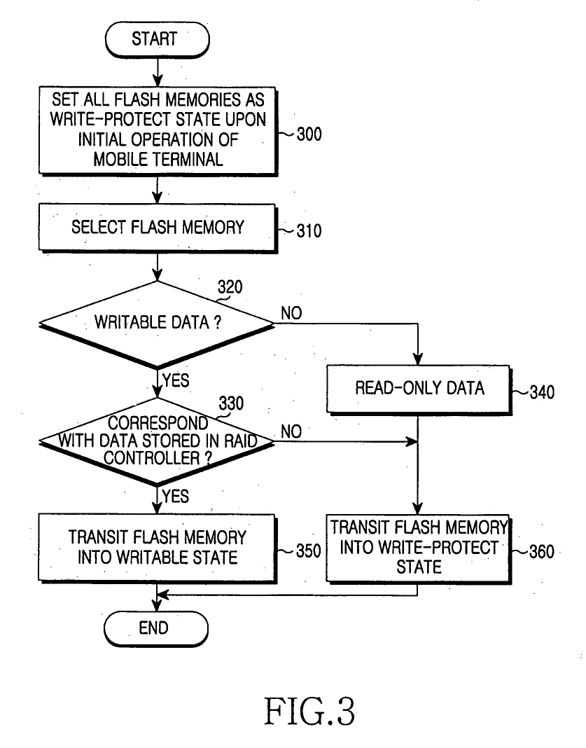

FIG. 3 illustrates the operation of the RAID system in the mobile terminal according to the present invention.

As shown in FIG. 3, at step 300, the RAID controller 130 receives a command from the CPU 110 and sets every flash memory 120 to a write-protect state in order to perform the initial operation of the mobile terminal. At step 310, the selection unit 150 selects the area of a flash memory 120 to operate from among the N flash memories according to a command received through the input unit 140.

Then, at step 320, the state management unit 170 checks whether data stored in the area of the flash memory 120 refers to writable or read-only data so as to recognize the state of each flash memory 120 selected by the selection unit 150.

When it is determined through the search of the state management unit 170 that data stored in the area of the flash memory 120 refers to writable data, the comparison unit 180 compares the data with data stored in the storage unit 160 so as to determine whether the two pieces of data correspond with each other (step 330). In contrast, when it is determined through the search of the state management unit 170 that data stored in the area of the flash memory 120 refers to read-only data, the area of the read-only data is set as a write-protect state in the area of a first flash memory 120 in step 340.

When it is determined through the comparison of the comparison unit 180 that the data stored in the area of the current flash memory 120 correspond with the data stored in the storage unit 160, the state management unit 170 transits the area of the flash memory 120 storing the writable data into a writable state in step 350. In contrast, when the data stored in the area of the current flash memory 120 does not correspond with the data stored in the storage unit 160, the state management unit 170 transits the area of the flash memory 120 storing the writable data into a write-protect state so as to prevent data in the flash memories from being unintentionally modified in step 360.

According to the present invention as described above, a plurality of flash memories storing important data for performance in a mobile terminal are recognized as one or more areas, thereby providing a large amount of storage space, securing the reliability of stored data, and improving an access rate to the stored data.

Additionally, it is also possible to prevent a unintentional modification of data by setting the area of a flash memory, in which important data for performance in a mobile terminal has been stored, as a write-protect area.

While the invention has been shown and described with reference to certain exemplary embodiments thereof, it will be understood by those skilled in the art that various changes in form and details may be made therein without departing from the spirit and scope of the invention as defined by the appended claims.

1. A Redundant Arrays of Independent Drives (RAID) system in a mobile terminal, the RAID system comprising:
a plurality of flash memories for storing data used to perform an operation in the mobile terminal, said flash memories being included in at least one area; and
a RAID controller for controlling the plurality of flash memories included in the at least one area.

2. The RAID system as claimed in claim 1, wherein the RAID controller comprises:
an input unit for receiving a command from a central processing unit and performing the command;
a selection unit for selecting the flash memory according to the command received though the input unit; and
a storage unit for storing the data about an initial state of the flash memory.

3. The RAID system as claimed in claim 2, wherein the RAID controller further comprises:
a comparison unit for comparing data of the storage unit with data currently stored in the flash memory to determine whether the two pieces of data correspond with each other; and
a state management unit for searching the flash memory and managing the flash memory to be in a write-protect state or writable state through comparison in the comparison unit based on a data state of the searched flash memory.

4. The RAID system as claimed in claim 3, wherein the comparison unit performs the comparison according to a command received from the central processing unit.

5. The RAID system as claimed in claim 1, wherein the flash memories further comprise a first data area including code data for operation performance of the mobile terminal, a master boot record area, a File Allocation Table (FAT) area of a file system, and a second data area for storing data in a unit area.

6. The RAID system as claimed in claim 5, wherein the flash memories operate in one or more areas according to a control command of the selection unit.

7. The RAID system as claimed in claim 6, wherein each of the flash memories is set in a writable state or write-protect state according to a control command of the state management unit.

8. The RAID system as claimed in claim 1, wherein the RAID system in the mobile terminal uses one of RAID levels 1, 2, 3, 4 and 5.

9. A Redundant Arrays of Independent Drives (RAID) method in a mobile terminal, the RAID method comprising the steps of:
receiving, by a RAID controller, a command from a central processing unit so that the mobile terminal performs an operation; and
recognizing a plurality of flash memories as at least one area according to a command received by the RAID controller.

10. The RAID method as claimed in claim 9, wherein the RAID controller performs a selection operation to operate at least one flash memory.

11. The RAID method as claimed in claim 9, wherein, when recognizing the flash memories, the RAID controller sets all of the flash memories in a write-protect state.

12. The RAID method as claimed in claim 11, further comprising the steps of:
comparing writable data with data stored in the RAID controller so as to determine whether the two pieces of data correspond with each other according to a command from the central processing unit, when the flash memory stores the writable data; and
transiting, by the RAID controller, the flash memory into a write-protect state, when the writable data does not correspond with the data stored in the RAID controller.

13. The RAID method as claimed in claim 12, further comprising transiting the flash memory into a writable state, when the writable data corresponds with the data stored in the RAID controller.

14. The RAID method as claimed in claim 12, further comprising setting the flash memory in a write-protect state when the flash memory stores read-only data.
